(19) United States
(12) Patent Application Publication
(10) Pub. No.: US 2016/0342512 A1
(43) Pub. Date: Nov. 24, 2016

(54) STORAGE SYSTEM AND PROCESSING METHOD

(71) Applicant: HITACHI, LTD., Tokyo (JP)

(72) Inventors: Yuki SAKASHITA, Tokyo (JP); Shintaro KUDO, Tokyo (JP); Yoshihiro YOSHII, Tokyo (JP); Yusuke NONAKA, Tokyo (JP)

(21) Appl. No.: 14/424,625

(22) PCT Filed: Jan. 21, 2014
(86) PCT No.: PCT/JP2014/051104

§ 371 Date: Feb. 27, 2015

(51) Int. Cl. G06F 12/0804; G06F 12/0866

(52) U.S. Cl. CPC G06F 12/0804; G06F 12/0866; G06F 2212/1008; G06F 2212/281; G06F 2212/313

(57) ABSTRACT

The invention provides a technique for improving processing performance of I/O commands in a storage system in which ownership of each LU is introduced. The storage system includes: a disk device having storage regions that are managed as a plurality of logical units; a plurality of processors that process read commands to the disk device; and a cache that the processors can use to process the read commands. An owner processor that is in charge of processing to each logical unit is allocated to each logical unit. When decision is made that dirty data is not present in the cache in a target region of the read command, there are a case where the owner processor of a logical unit that includes the target region processes the read command, and a case where a non-owner processor, as the processor other than the owner processor, processes the read command.

### TECHNICAL FIELD

The present invention relates to performance enhancement of a storage system.

### BACKGROUND ART

According to a storage system disclosed in PTL 1 (WO 2013/051069), by allocating in advance an MPPK (Micro Processor Package) for executing the processing of an I/O (input and output) command in each LU (Logical Unit), an exclusive processing between controllers when accessing a CD (Cache Directory) as management information of a CM (Cache Memory) is avoided. With this arrangement, performance of the storage system is enhanced.

In the storage system in PTL 1, when a cache hit rate of a read I/O is low, a part of the processing of data caching control is omitted. With this arrangement, performance of the storage system in PLT 1 is also enhanced.

### CITATION LIST

### Patent Literature

### [PTL 1]

### WO 2013/051069

### SUMMARY OF INVENTION

### Technical Problem

According to the configuration of PTL1, performance of the system improves when I/O commands are dispersed in a plurality of LUs. However, when the I/O commands are concentrated in one LU, there arises a state that only the owner MPPK of the LU in which the I/O commands are concentrated processes the I/O commands, and other MPPKs do not execute processings. Therefore, the system performance becomes low.

Further, in the storage system that uses low-price hardware on which an exclusive LSI that executes allocation of commands and the like are not mounted, the MPPK must execute the processing of allocating the commands to the owner MPPK. Regarding I/O commands to the LU which the MPPK on the controller directly connected to a host I/F (Interface) is not the owner, there occurs a processing for the MPPK on the controller directly connected to the host I/F to allocate the I/O commands to the owner MPPK. Therefore, as compared with processing performance of I/O commands to the LU which the MPPK on the controller directly connected to the host I/F is the owner, processing performance of I/O commands to the LU which the MPPK on the controller not directly connected to the host I/F is the owner becomes low.

An object of the present invention is to provide a technique for improving processing performance of I/O commands in a storage system in which ownership of each LU is introduced.

### Solution to Problem

A storage system according to one mode of the present invention includes: a disk device having storage regions which are managed as a plurality of logical units; a plurality of processors that process read commands to the disk device; and a cache that the processors can use to process the read commands. An owner processor that is in charge of processing to each of the logical units is allocated to each of the logical units. When decision is made that dirty data is not present in the cache in a target region of the read command, there are a case where the owner processor of a logical unit that includes the target region processes the read command, and a case where a non-owner processor, as the processor other than the owner processor, processes the read command.

### Advantageous Effects of Invention

According to the present invention, in a storage system in which I/O processing performance is improved by introducing ownership to make it unnecessary to access a cache directory, performance of the system can be improved by averaging the processing performance among LUs and by improving performance of the LUs by dispersing the load even when I/O processings are concentrated in one LU.

### BRIEF DESCRIPTION OF DRAWINGS

FIG. 1 is configuration diagram of a storage system according to Embodiment 1.

FIG. 2 is a block diagram showing information that is stored in a main memory 102 according to Embodiment 1.

FIG. 3 is a diagram showing a configuration example of a DCT 1022.

FIG. 4 is a diagram showing a configuration example of a hit rate management table 1021.

FIG. 5 is a diagram showing a configuration example of a CB mode management table 10250.

FIG. 6 is a diagram showing a configuration example of an LCD 1023.

FIG. 7 is a flowchart of a read I/O processing by an MPPK in charge of port.

FIG. 8 is a flowchart of a read I/O processing by an owner MPPK.

FIG. 9 is a flowchart of a frontend write I/O processing by the MPPK in charge of port.

FIG. 10 is a flowchart of a frontend write I/O processing by the owner MPPK.

FIG. 11 is a flowchart of a backend write I/O processing by the owner MPPK.

FIG. 12 is a flowchart of a CB mode ON/OFF changeover processing.

FIG. 13 is a flowchart of a DCT update processing.

FIG. 14 is a block diagram showing information which is stored in the main memory 102 in Embodiment 2.

FIG. 15 is a diagram showing an example of an operating rate management table 1027.

FIG. 16 is a flowchart of a read I/O processing by the MPPK in charge of port.

FIG. 17 is a flowchart of a read I/O processing by an MPPK not in charge of port.

FIG. 18 is a flowchart of a read I/O processing (S220) by the owner MPPK.

### DESCRIPTION OF EMBODIMENTS

Embodiments of the present invention will be described with reference to the appended drawings. To clarify the explanation, details of the following descriptions and drawings are suitably omitted and simplified, and redundant descriptions will be omitted when necessary. The embodiments are only examples to realize the present invention, and do not limit a technical range of the present invention.

### Embodiment 1

In a storage system according to Embodiment 1, by using grouped units of a plurality of MPs (Micro Processors) called MPPKs, MPPKs that are in charge of input and output to and from LUs, that is, owner MPPKs, are allocated.

A main memory is allocated to each MPPK. The main memory is representatively a volatile semiconductor memory.

The main memory includes an SM (Shared Memory) which a plurality of MPPKs in charge of different LUs can access each other. Data caching control information of the LU that each MPPK is in charge of is stored in the SM. The data caching control information is also stored in an LCD (Local Cache Directory) of the processor.

Each MPPK executes data caching control of the LU that the MPPK is in charge of, by referring to and updating the LCD on the main memory that the owner MPPK exclusively has. Accordingly, the data caching control processing can be speeded up. When necessary, only updating is executed to the data caching control information on the SM.

As described above, a plurality of MPPKs in charge of different LUs can access the SM. When a trouble occurs in the MPPK in charge of any LU, other MPPK takes over the role, copies corresponding data caching control information from the SM into the LCD, and controls the data caching of the taken-over LU.

To the storage system in Embodiment 1, a host computer transfers a command by assigning a port out of host I/Fs. When the command has been received by each port of the storage system, an MPPK that refers to the command is allocated to each port. The MPPK allocated to each port is called a MPPK in charge of port. By determining the MPPK in charge of port in advance in this way, an exclusive processing between the MPPKs at the time of referring to the command becomes unnecessary. The MPPK in charge of port refers to the received command, determines which MPPK is the owner of the command, and allocates the command to the owner MPPK.

In the storage system in Embodiment 1, when the owner MPPK processes a write command, the owner MPPK executes the write to CMs of a plurality of controllers, and returns a response to the host computer upon completing the write to the CMs. By returning the response to the host computer at the time point of the completion of the write to the CMs in this way, response performance of the response to the host computer improves, as compared with the response performance of returning the response after writing to the disk device.

The processing from completion of reception of the write command to the completion of the write to the CMs is called a frontend write processing. Data in the state that the data has been written into the CMs and writing into the disc device (destage processing) has not been completed is called dirty data.

Thereafter, the dirty data on the CM is written into the disk device, and the dirty data of which writing into the disk device has been completed is changed into clean data that means that the destage has been completed. This processing is executed asynchronously with the frontend write processing, and is called a backend write processing.

In the storage system according to Embodiment 1, when the owner MPPK executes a read command processing, the owner command MPPK checks whether target data is dirty data, by referring to the data caching control information. When the owner MPPK has determined that the target data is dirty data, that is, the latest data is on the CM and the data in the disk device is old data, the owner MPPK returns the dirty data on the CM to the host computer.

The storage system according to Embodiment 1 has a mode called a CB mode (Cache Bypass mode) of which ON/OFF can be changed over according to a cache hit rate.

The CB mode becomes ON, in each LU, when a cache rate of the cache is less than a threshold value. When the CB mode is ON, in the read I/O processing, data which has been read from the disk device is returned to the host computer, after being stored in a temporary region called a DXBF (Data Transfer Buffer), not the CM. With this arrangement, because the load of the data caching control can be reduced, the read I/O performance can be improved.

A difference between the CM and the DXBF will be described. For the CM, a state whether each data is dirty or clean, and what data is being stored on the CM are managed. Therefore, when storing data on the CM, updating of the management information is involved. On the other hand, for the DXBF, because a state of data is not managed, when storing data into the DXBF, updating of the data is not necessary because there is no management information. Therefore, data can be stored into the DXBF faster than storing the data on the CM.

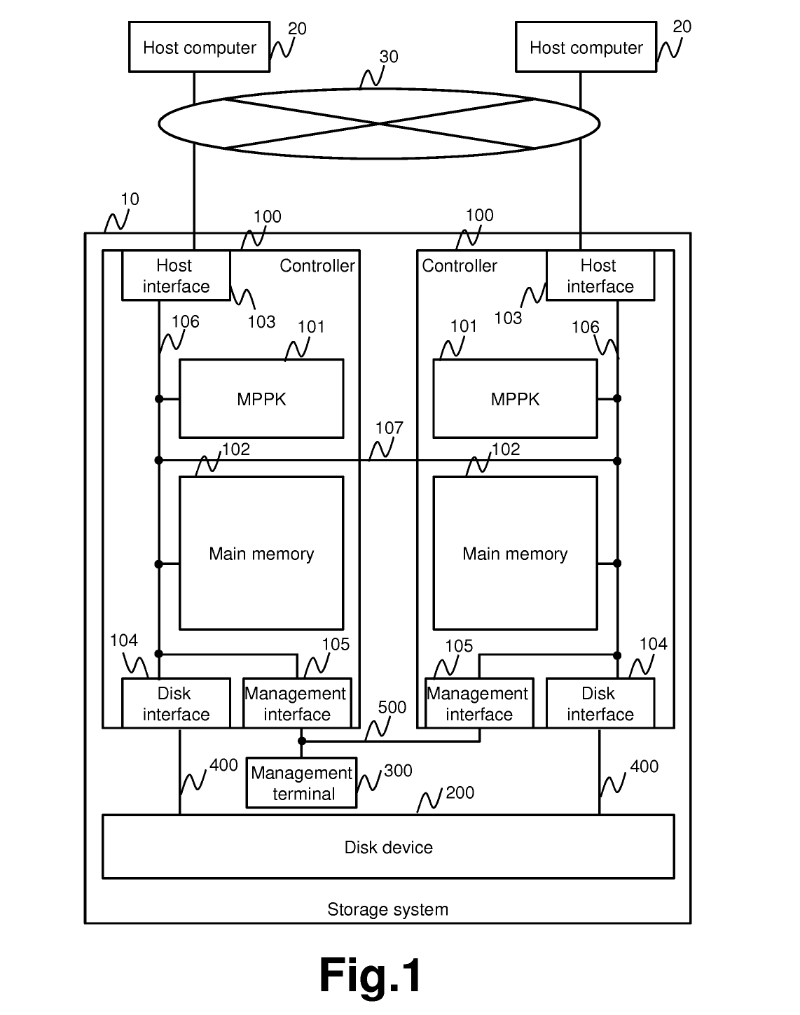

Hereinafter, Embodiment 1 will be described in detail with reference to FIGS. 1 to 13.

FIG. 1 is a configuration diagram of the storage system according to Embodiment 1.

A storage system 10 is connected to host computers 20 via a network 30. The data network 30 is a SAN (Storage Area Network) as an example. However, the data network 30 may be an IP network, or any other kind of data communication network.

The storage system 10 and a management terminal 300 are connected to each other via a management network 500. The management network 500 may be a SAN, an IP network, or any other kind of network.

The storage system 10 includes one or more controllers 100. In the example of FIG. 1, two controllers 100 are shown. On the substrate of the controller 100, there are provided one or more MPPKs 101, one or more main memories 102 allocated to the MPPKs, one or more host interfaces 103, one or more disk interfaces 104, and one or more management interfaces 105. These devices are connected to each other by an internal network 106.

When there are two or more controllers 100, the controllers 100 are connected to each other by one or more I paths (Interconnect Paths) 107. The MPPK 101 of the controller 100 can access the main memory 102 of other controller 100 via the I path 107.

As a method of connecting between the controllers 100 by the I path 107, there may be employed any one of a method of connecting by using a function of the MPPK 101, a method of connecting by using a switch, and a method of connecting by using any other device or function.

The MPPK 101 communicates with the host computer 20 via the host interface 103.

The MPPK 101 communicates with a disk device 200 via the disk interface 103.

The MPPK 101 communicates with the management terminal 300 via a management interface 105.

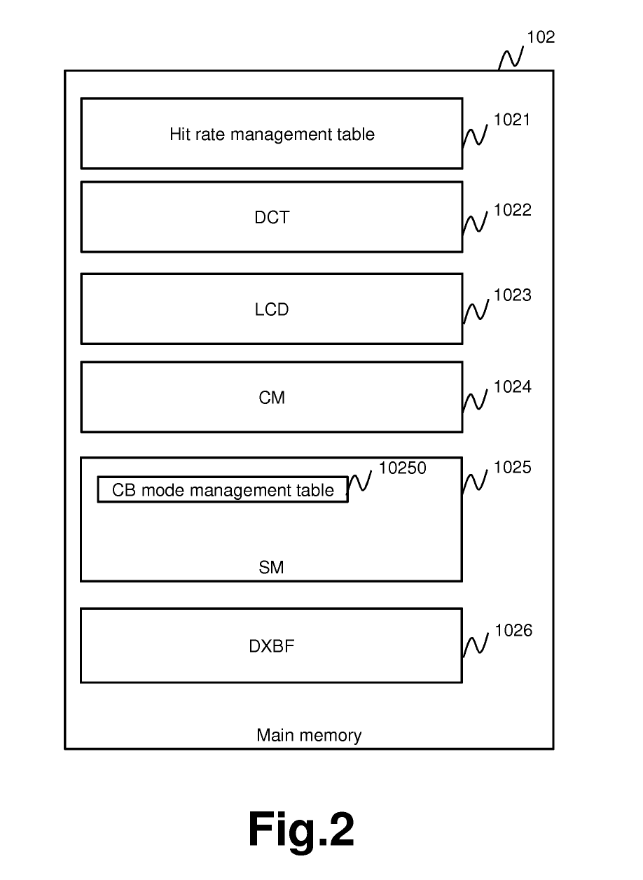

FIG. 2 is a block diagram showing information that is stored in the main memory 102 according to Embodiment 1.

The main memory 102 includes a hit rate management table 1021, and a DCT (Dirty Check Table) 1022. Details of these tables will be described later.

Further, the main memory 102 includes an LCD (Local Cache Directory) 1023, a CM 1024, an SM (Shared Memory) 1025, and a DXBF 1026. The SM 1025 includes a CB mode management table 10250.

The MPPK 101 stores the data caching control information of the SM 1025 as cache in the LCD 1023, and reflects the updating of the cache on the LCD 1023 to the data caching control information of the SM 1025, when necessary.

Upon receiving a read command from the host computer 20, the MPPK 101 decides whether target data has been cached by the CM 1024 (cache hit), by referring to the LCD 1023 of the main memory 102. In this way, the LCD 1023 provides information that enables the MPPK 101 to know whether the cache data has been stored in the CM 1024.

The DXBF 1026 is a temporary region that the storage system uses at the time of exchanging data with the host computer 20 and the disk device 200. According to Embodiment 1, the DXBF 1026 is distinguished from other region that the main memory 102 has. However, a part of the CM 1024 may be also temporarily used as a region corresponding to the DXBF, for example.

The CB mode management table 10250 is a table that shows a correspondence relationship between the LU number and the CB mode ON/OFF.

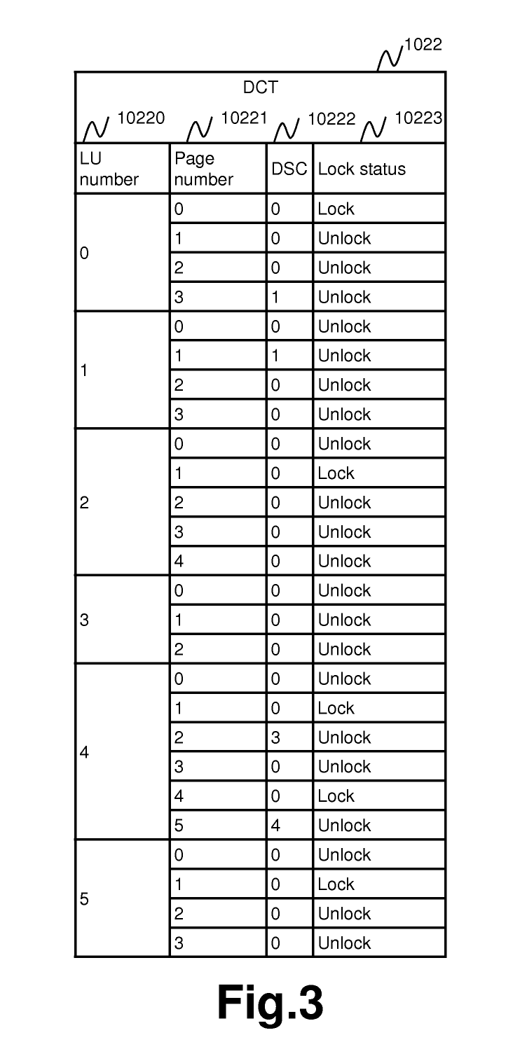

FIG. 3 is a diagram showing a configuration example of the DCT 1022. Referring to FIG. 3, the DCT 1022 is configured by an LU number field (column) 10220, a page number field 10221, a DSC (Dirty Slot Counter) field 10222, and a lock status field 10223. The DCT is a table that provides information of a DSC which counts a dirty slot number, and information about whether the page is being locked or unlocked, based on the LU number and the page number that are obtained by command analysis.

In the storage system 10 according to Embodiment 1, one LU is managed by dividing the LU into a plurality of pages, further, one page is managed by dividing the page into a plurality of slots, and further, one slot is managed by dividing the slot into a plurality of sub-slots. Arbitrary sizes can be selected for a page size and a slot size.

The storage system according to Embodiment 1 has information for managing whether dirty data is included in a slot unit (not shown).

In the storage system 10 according to Embodiment 1, the DCT 1022 is referred to when the MPPK in charge of port has received a read command from the host computer 20. By obtaining a target LU number and a target address from the command, a page number can be calculated from the page number. A calculation method may be that a value obtained by dividing the target address by the page size is used as a page number, for example.

By searching the LU number field 10220 and the page number field 10221 for the obtained LU number and the obtained page number, respectively, a target record (row) can be instantly accessed.

A value of the DSC field 10222 indicates how many slots including dirty data are included in each page.

When the value of the DSC field 10222 is larger than 0, there is a possibility that dirty data is included in the page. Therefore, it can be decided that LCD access is necessary to decide whether read target data is dirty data.

When the value of the DSC field 10222 is 0, this indicates that no dirty data is included in the page, and accessing the LCD is not necessary. Therefore, the MPPK other than the owner MPPK can also execute the read I/O processing.

As described above, according to the conventional technique, when the MPPK in charge of port and the owner MPPK are on different controllers, the command needs to be transferred from the MPPK in charge of port to the owner MPPK across the different controllers, and this becomes a cause of reduction in the processing performance. However, in the present embodiment, by omitting the transfer across the different controllers, the read I/O processing in the storage system can be speeded up.

The lock status field 10223 takes a value of either lock or unlock. When any MPPK or MP has obtained lock, the value of the lock status field 10223 becomes lock.

This lock is for exclusively executing the updating of the DCT, and is different from the lock of CD that became unnecessary due to the introduction of ownership.

A proportion of a processing time occupied by the DCT update processing in a total I/O processing can be set sufficiently small. Therefore, a possibility of contention among the MPPKs is sufficiently small, and the lock of the lock status field 10223 has little influence on the I/O performance.

As other configuration examples of the DCT 1022, in addition to the method of holding the number of dirty slots as a counter like the DSC 10222, it is also possible to manage by, for example, a method that by preparing bits by the number of slots, when each slot includes dirty data, corresponding bits are set from 0 to 1, and when the slots do not include dirty data by destage, corresponding bits are changed from 1 to 0.

As described later, according to Embodiment 1, count up of the DSC 10222 is executed along a frontend write I/O processing, and count down is executed along a backend write I/O processing. However, count down is not limited to this system. As other example, by periodically calling the processing of executing the count down, the DSC 10222 may be counted down.

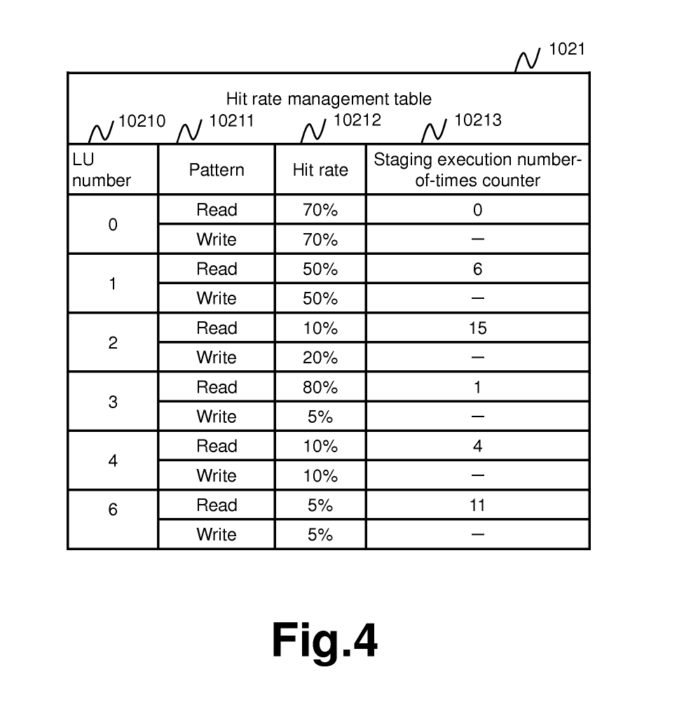

FIG. 4 is a diagram showing a configuration example of the hit rate management table 1021. The hit rate management table 1021 is configured by an LU number field 10210, a pattern field 10211, a hit rate field 10212, and a staging execution number-of-times counter field 10213. The hit rate management table 1021 is a table that provides information of a caching hit rate and a staging execution number-of-times counter, based on the LU number and the I/O pattern (read or write) that are obtained by command analysis.

The MPPK 101 refers to the hit rate management table 1021 when deciding the ON/OFF of the CB mode. By obtaining a target LU number and an I/O pattern (read or write) from the command, a target record can be instantly obtained from the LU number field 10210 and the pattern field 10211.

By comparing the hit rate field 10212 of the record and a predetermined threshold value, it can be decided whether the CB mode should be applied to the LU.

Updating of the hit rate field 10212 can be executed at the time of executing a cache hit rate decision, for example, or may be periodically executed.

A threshold value for changing over the CB mode ON/OFF may be set in each LU. In this case, a threshold field (not shown) may be added to each record.

When the CB mode is valid, MPPk 101 refers to the staging execution number-of-times counter field 10213 of the record and implements data stage to the CM 1024, only when the counter value of the record is an upper limit value.

The staging execution number-of-times concerns only the read processing. Therefore, the staging execution number-of-times counter field 10213 stores a value of only the record for which the pattern field 10211 is read.

Updating of the staging execution number-of-times counter field 10213 is counted up at the time of executing the staging. The staging performance in this case includes a case where data is stored in the CM 1024 and a case where data is transferred to the DXBF 1026 without being stored in the CM 1024.

When the CB mode is ON and when the value of the counter is the upper limit value, data is stored in the CM 1024 at the time of executing the staging. On the other hand, when the CB mode is ON and when the value of the counter is other than the upper limit value, data is not stored in the CM 1024 at the time of executing the staging, the data is returned to the DXBF 1026 on the main memory, and the data is returned to the host computer 20. For example, when the upper limit value of the staging execution number-of-times counter is 15, data is stored in the CM 1024 at only once per staging performance at 16 times.

In a case where the I/O processing is continued in the state that the CM 1024 is not updated at all when the CB mode is ON, there exists no recently-accessed data on the CM 1024, and it cannot be decided whether the access to the cache is in the hit trend or the error trend. In order to avoid this problem, by introducing the staging execution number-of-times, and by updating the CM 1024 by a part of the I/O processing as sampling, it is made possible to obtain the information of the access trend.

The upper limit value of the staging execution number-of-times counter may be determined by fixing, or may be changed according to the hit rate.

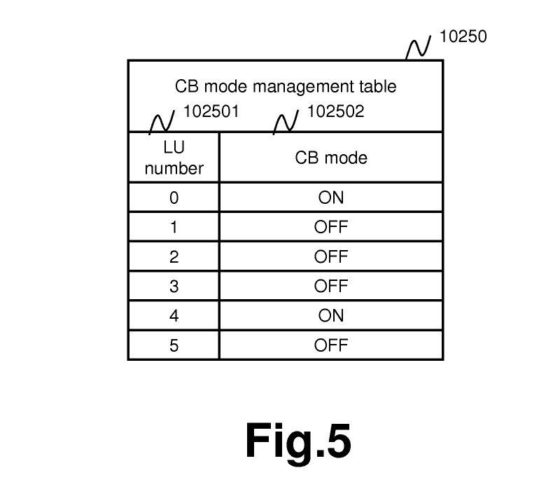

FIG. 5 is a diagram showing a configuration example of the CB mode management table 10250.

The CB mode management table 10250 is configured by an LU number field 102501, and a CB mode field 102502. From the CB mode management table 10250, information about whether the CB mode of each LU is ON or OFF is provided.

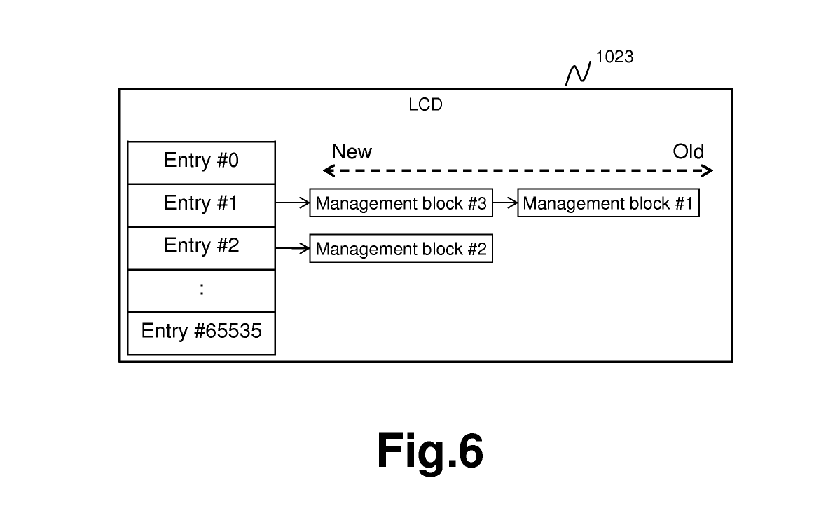

FIG. 6 is a diagram showing a configuration example of the LCD 1023.

The LCD 1023 provides information for managing the state of data on the CM 1024, and managing the address on the disk device 200.

The LCD 1023 has a plurality of entries, and determines what order of entry the MPPK 101 should access in the I/O processing, based on a hash value determined from the LU number and the slot number. Further, each entry has a plurality of management blocks.

The management block has information about whether the slot is dirty or clean, and information about which data included in the slot is being stored on the CM 1024.

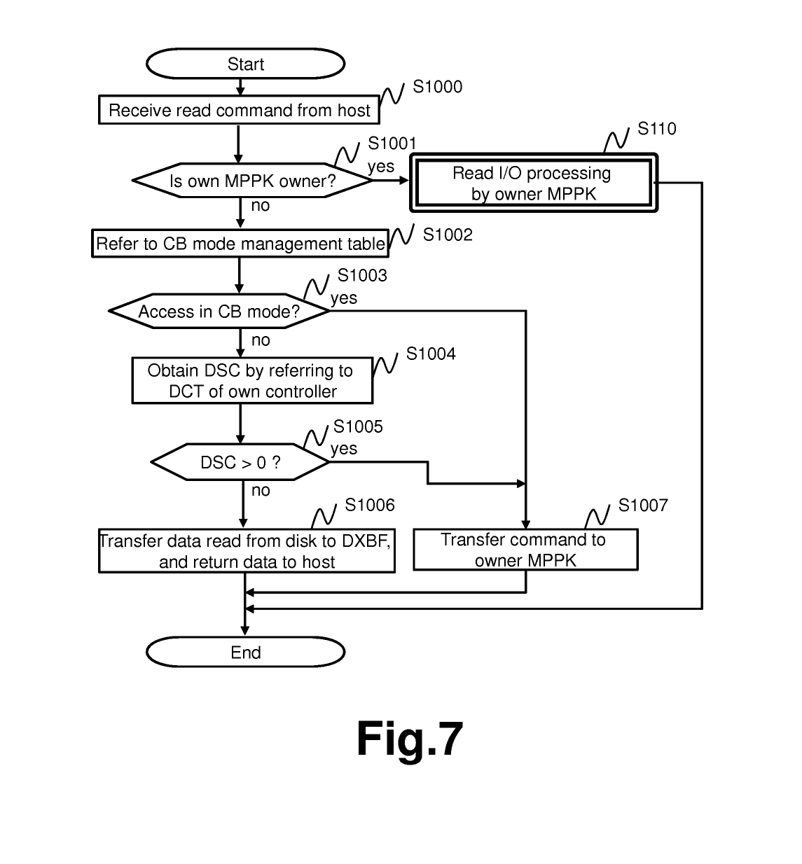

The I/O processing flow according to Embodiment 1 will be described with reference to FIGS. 7 to 13.

FIG. 7 is a flowchart of the read I/O processing by the MPPK in charge of port.

After the storage system 10 receives the read command from the host computer 20, the MPPK in charge of port executes the processing (S1000).

The MPPK in charge of port analyzes the command, obtains the information of the target LU number, obtains the owner MPPK information from the target LU number, and decides whether the own MPPK (the MPPK in charge of port) is the owner (S1001). As a method of obtaining the owner MPPK from the LU number, by preparing a table, the owner information which determines in advance a correspondence relationship between the LU and the owner MPPK may be stored in the table. The owner MPPK may be determined based on the hash value of the LU number, or any other method may be used.

The MPPK in charge of port executes the read I/O processing (S110) of the owner MPPK, when the own MPPK is the owner (S1001: yes). Alternatively, by copying the command in advance in the region that the self refers to, the MPPK in charge of port may execute the processing later. The flow of S110 will be described later.

When the own MPPK is not the owner (S1001: no), the MPPK in charge of port determines (S1003) whether the I/O to the target LU is to be processed in the CB mode (the CB mode ON) or in the normal mode (the CB mode OFF), by referring to the CB mode management table 10250 (S1002). For example, as a method of deciding whether the I/O to the target LU is to be processed in the CB mode, the value of the hit rate field 10212 in the hit rate management table 1021 is referred to, and it is decided whether the I/O to the target LU is to be processed in the CB mode ON, depending on whether the value is equal to or lower than the threshold value.

In the case of accessing in the normal mode (S1003: yes), it is necessary that the owner MPPK processes the read I/O. Therefore, the MPPK in charge of port transfers the read command to a region (not shown) which the owner MPPK periodically refers to (S1007). As a result, the owner MPPK can process the command.

In the case of accessing in the CB mode (S1003: no), when there is no dirty data in the page that includes a target address, a non-owner MPPK cannot execute the read I/O processing. Therefore, the MPPK in charge of port first obtains the LU number and the target address from the command, and calculates a corresponding page number from the target address.

Next, the MPPK in charge of port refers to the DCT 1022 of its own system and obtains a target record from the LU number field 10220 and the page number field 10221, and obtains a DSC value from the DSC field 10222 (S1004).

As described above, by deciding whether the number of dirty data is 0, in a page unit larger than the sub-block or the slot of data, it is possible to decide instantly whether the non-owner MPPK can execute the read I/O processing.

When DSC is larger than 0, that is, when a slot having dirty data (a dirty slot) is included by one or more in a page (S1005: yes), the MPPK in charge of port needs to implement the cache hit error decision by accessing the LCD 1023. Therefore, the MPPK in charge of port transfers the command to a region that the owner MPPK periodically refers to (S1007).

When DSC is 0, that is, when there is no dirty slot in the page (S1005: no), the MPPK in charge of port reads the data from the disk device 200, does not store the data into the CM 1024, but once stages the data in the DXBF 1026 of the main memory, and returns the data to the host computer 20 (S1006).

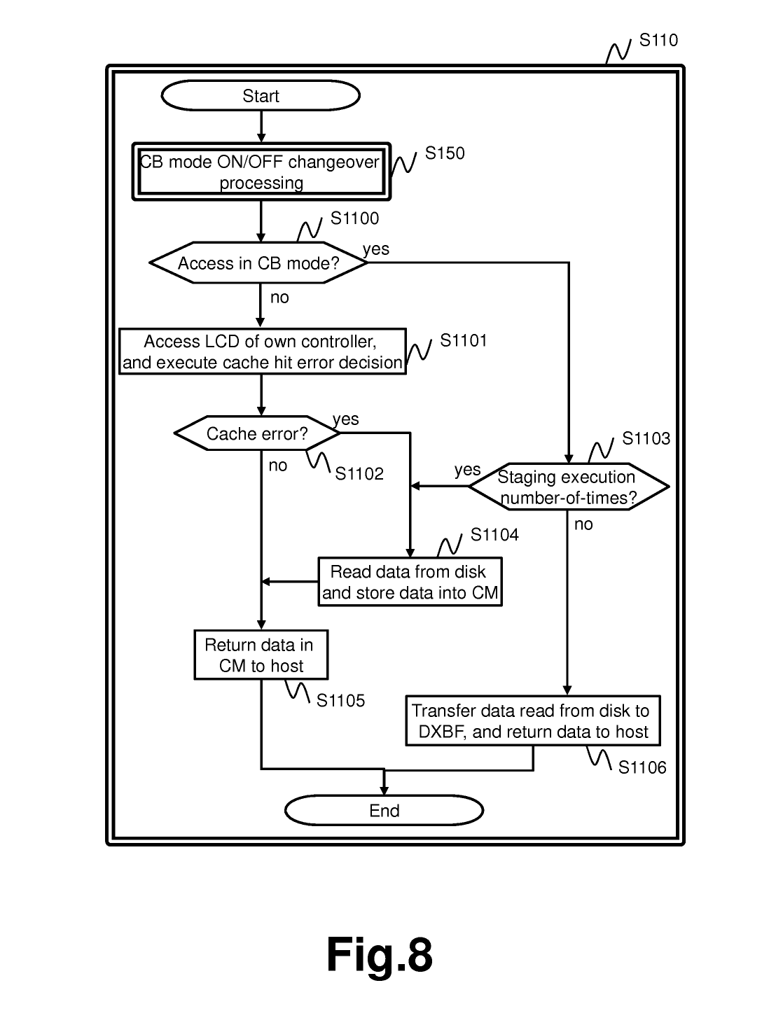

FIG. 8 is a flowchart of the read I/O processing by the owner MPPK. This processing is executed when the owner MPPK of the command that the MPPK in charge of port has received is the own MPPK, or is executed when the command to the LU in which the own MPPK is the owner has been received from a separate MPPK.

First, a CB mode ON/OFF changeover processing (S150) is executed. This is a processing for deciding the ON/OFF of the CB mode, by obtaining the cache hit rate of the I/O to the target LU from the hit rate management table 1021, and by comparing the cache hit rate and the threshold value. The flow of S150 will be described in detail later.

By using the decision result in S150, it is decided whether access is executed in the CB mode or in the normal mode (S1100).

In the case of accessing in the CB mode (S1100: yes), it is decided whether the staging execution number-of-times is an upper limit value, by referring to the staging execution number-of-times counter field 10213 of the hit rate management table 1021 (S1103).

In the case of the staging execution number-of-times (S1103: yes), the MPPK 101 stores the data read from the disk device 200 into the CM 1024 (S1104), and then returns the data in the CM 1024 to the host computer 20 (S1105).

In the case of not the staging execution number-of-times (S1103: no), the MPPK 101 destages the data read from the disk device 200 to the DXBF 1026 of the main memory 102, and returns the data to the host computer 20 (S1106).

In the case of accessing in the normal mode (S1100: no), the LCD 1023 of the own controller is accessed, and the cache error decision is executed (S1101).

In the case of cache error (S1102: yes), the owner MPPK reads data from the disk device 200, stores the data into the CM 1024 (S1104), and then returns the data on the CM1024 to the host computer 20 (S1105).

In the case of cache hit (S1102: no), the owner MPPK returns the data in the CM 1024 to the host computer 20.

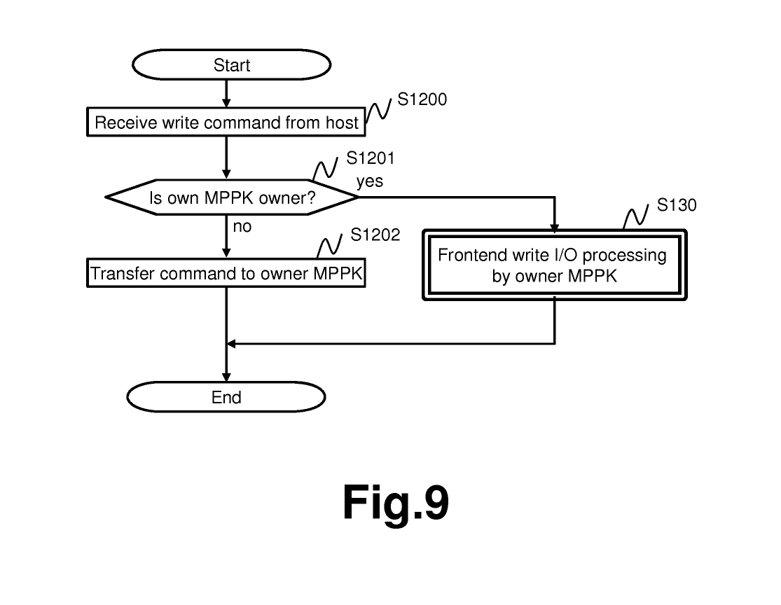

FIG. 9 is a flowchart of the frontend write I/O processing by the MPPK in charge of port.

After the storage system 10 receives the write command from the host computer 20, the MPPK in charge of port processes (S1200).

In a similar manner to that in S1001, the MPPK in charge of port analyzes the received command, and decides whether the own MPPK is the owner of the target LU of the write command (S1201).

When the own MPPK is the owner (S1201: yes), the MPPK in charge of port executes the frontend write I/O processing (S130) of the owner MPPK. Alternatively, the command may be copied in advance in the region that the self refers to, and may be executed later. The flow of S130 will be described in detail later.

When the own MPPK is not the owner (S1201: no), the MPPK in charge of port transfers the write command to a region (not shown) that the owner MPPK periodically refers to (S1202).

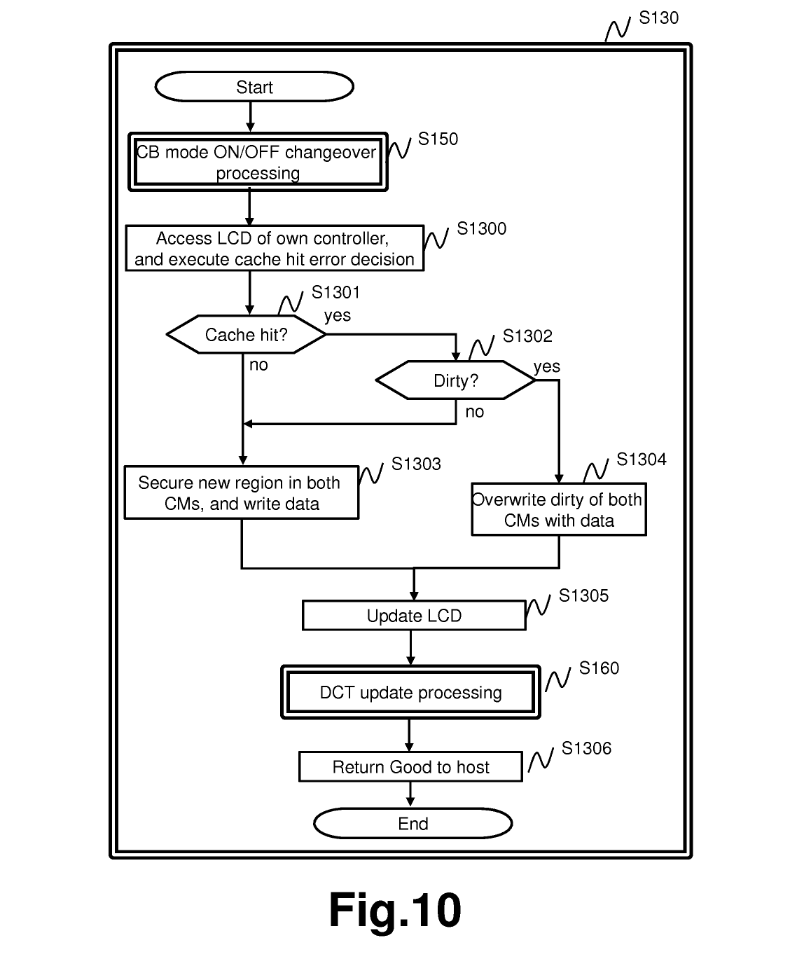

FIG. 10 is a flowchart of the frontend write I/O processing by the owner MPPK.

First, the owner MPPK executes the CB mode ON/OFF changeover processing (S150). The flow of S150 will be described in detail later.

Next, the owner MPPK executes the cache hit error decision by accessing the LCD 1023 of the own controller (S1300).

In the case of cache hit (S1301: yes), the owner MPPK decides whether the hit data is dirty data (S1302).

When the hit data is dirty data (S1302: yes), the owner MPPK overwrites the dirty data in the CMs 1024 of both controllers with new data (S1304). When the hit data is clean data (S1302: no), the owner MPPK secures new regions in the CMs 1024 of both controllers and writes the data (S1303).

In the case of cache error (S1301: yes), the owner MPPK also secures new regions in the CM 1024 of the both controllers and writes the data (S1303).

After the writing of the data into the CM 1024 has been completed (S1303 or S1304), the owner MPPK updates the LCD 1023 (S1305). In this case, because the slot has dirty data, the owner MPPK executes the processing of changing a status of the slot from a clean slot to a dirty slot and the like.

Next, the owner MPPK executes the DCT update processing (S160). The DCT update processing during the frontend write I/O processing is a processing of adding the number of slots that have been changed to dirty slots, to the value of the DSC field 10222 of the DCT 1022. For the number of slots that have been changed to dirty slots, a calculated value is delivered as an argument, at the LCD updating time (S1305). The flow of S160 will be described in detail later. Last, the owner MPPK returns a Good response indicating the normal completion of the I/O, to the host computer 20 (S1306).

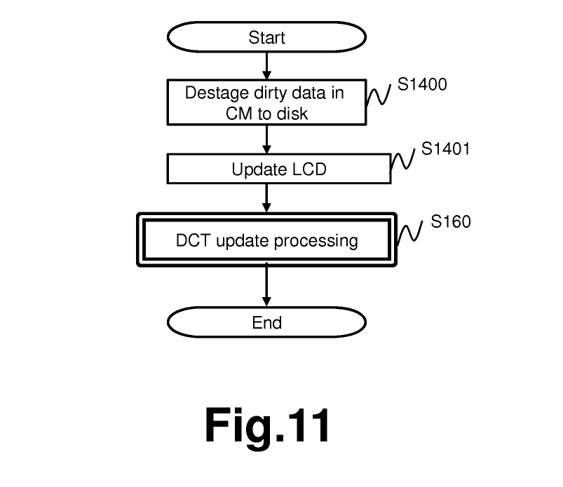

FIG. 11 is a flowchart of the backend write I/O processing by the owner MPPK. The backend write I/O processing is a processing that the owner MPPK periodically executes. After the backend write I/O processing is started, the MPPK 101 destages the dirty data in the CM 1024 to the disk device 200 (S1400).

Next, the owner MPPK updates the LCD 1023 (S1401). In this processing, for example, the status of the slot that does not include any dirty data by staging is changed from a dirty slot to a clean slot.

Next, the owner MPPK executes the DCT update processing (S160). The DCT update processing during the backend write I/O processing is a processing of subtracting the number of slots that have been cleaned by the destage, from a counter value of the DSC field 10222 of the DCT 1022. At the time of updating the LCD (S1401), the owner MPPK delivers the number of calculated clean slots to the processing in S160 as an argument. The flow of S160 will be described in detail later.

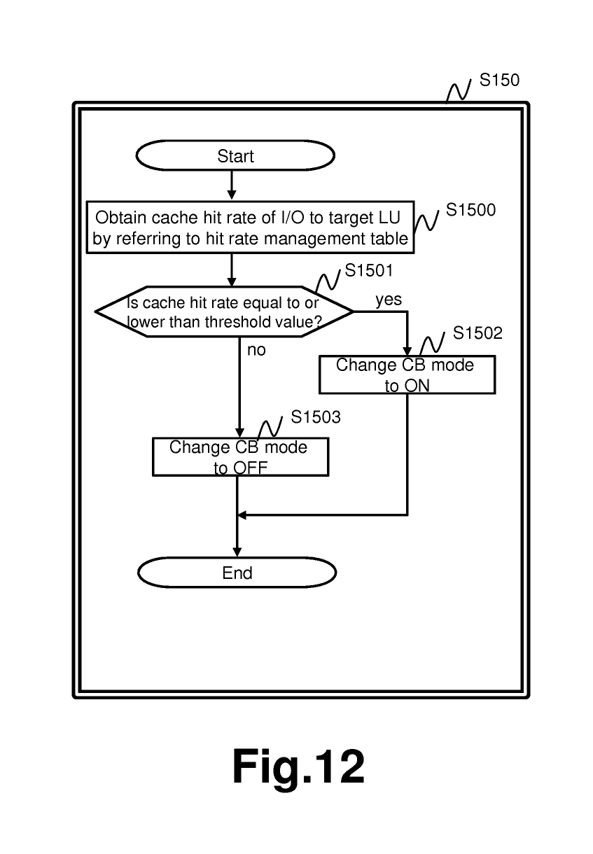

FIG. 12 is a flowchart of the CB mode ON/OFF changeover processing. The CB mode ON/OFF changeover processing is the processing in S150. First, the MPPK 101 obtains the I/O cache hit rate to the target LU, by referring to the hit rate management table 1021 (S1500). Next, the MPPK 101 decides whether the value of the hit rate field 10212 is equal to or lower than the threshold value (S1501).

When the cache hit rate is equal to or lower than the threshold value (S1501: yes), the MPPK 101 changes the CB mode of the LU in the CB mode management table 10250 to ON (S1502).

When the cache hit rate is equal to or higher than the threshold value (S1501: no), the MPPK 101 changes the CB mode of the LU in the CB mode management table 10250 to OFF (S1503).

In Embodiment 1, an example has been described that the non-owner MPPK can execute the read processing only when the CB mode is ON. However, the processing can be also applied to a system in which the CB mode is not installed. In this case, the processings in S1002 and S1003 in FIG. 7 are omitted.

According to the configuration of the present invention in which whether the read I/O processing is to be executed by the owner MPPK or by the non-owner MPPK is decided following the result of the DSC field 10222, the I/O transfer processing to the owner MPPK can be reduced by deciding a case where the non-owner MPPK can execute the read I/O processing in also the storage system in which ownership has been introduced. Therefore, the processing can be also applied to a system in which the CB mode is not installed.

There may be employed a method for enabling the non-owner MPPK to execute the I/O processing following the distribution of read and write of the I/O command, instead of the CB mode. For example, there may be employed a method for enabling the non-owner MPPK to execute the I/O processing to the LU of which the proportion of read is larger than that of write.

In the present invention, when the number of times of write is small, there is a high probability that the value of the DSC field 10222 is 0. That is, because there is a high probability that the non-owner MPPK can execute the read I/O processing, this decision method is valid in the storage system that is used in the state that each LU has a bias in the access pattern.

Further, a user may assign the setting by using the management terminal 300 so that, in each LU, the no-owner MPPK can also execute the read I/O processing.

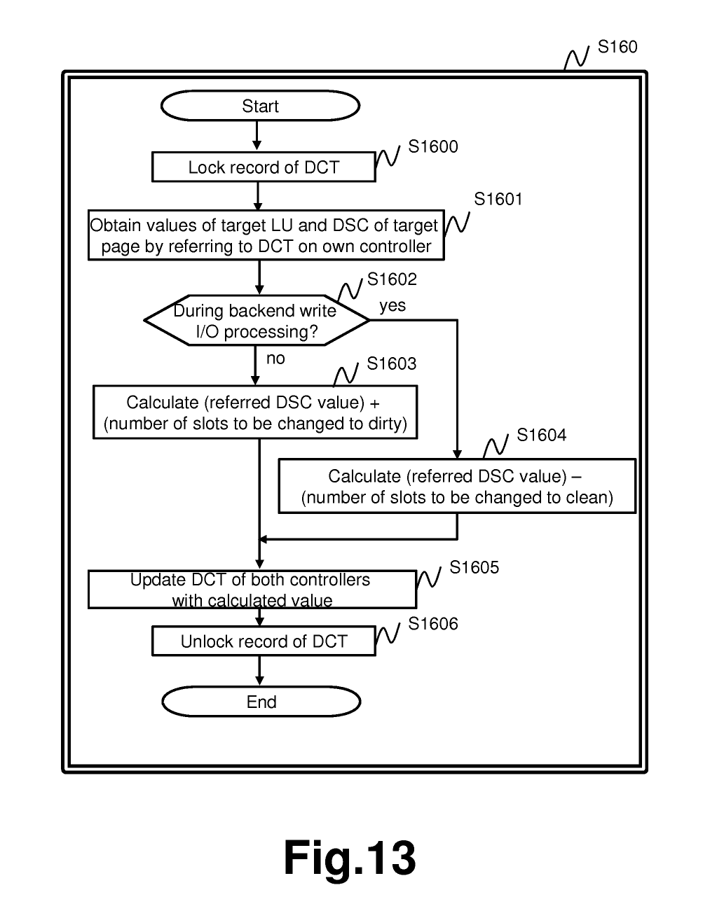

FIG. 13 is a flowchart of the DCT update processing. DCT update processing is the processing in S160 described above. There are two triggers of execution of the DCT update processing in S160. One trigger of the execution is a call during the frontend write I/O processing, and the other trigger of the execution is a call during the backend write I/O processing.

In the case of the call during the frontend write I/O processing, the call is executed to add the number of slots that have been changed to dirty, to the DSC field 10222 of the DCT 1022. In the case of the call during the backend write I/O processing, the call is executed to subtract the number of slots that are to be changed to clean, from the DSC field 10222 of the DCT 1022.

The MPPK 11 first analyzes the command as described above, obtains the LU number and the page number, and accesses a target record from the DCT 1022. Next, the MPPK 101 updates the lock status field 10223 of the record from unlock to lock, and locks the record (S1600). When the lock status field 10223 is already lock, other MPPK is accessing. Therefore, the MPPK 101 periodically checks the own field, and waits until the lock status field 10223 becomes unlock.

At the time of atomically updating the lock status field 10223 by read-modify-write, the updating may be executed by using the instruction installed in the CPU, or may be realized by using an exclusive LSI and the like.

Upon obtaining the lock, the MPPK 101 obtains values of the target LU and the DSC field 10222 of the target page by referring to the DCT 1022 on the own controller (S1601).

Next, the MPPK 101 decides whether the trigger of the call of the DCT update processing in S160 is during the backend write I/O processing (S1602).

When the point of the call of the DCT update processing in S160 is during the backend write I/O processing (S1602: yes), the MPPK 101 subtracts the number of slots that are to be changed to clean received as the argument, from the value of the DSC field 10222 referred to in S1601 (S1604).

When the point of the call of the DCT update processing in S160 is during the frontend write I/O processing (S1602: no), the MPPK 101 adds the number of slots that are to be changed to dirty received as the argument, to the value of the DSC field 10222 referred to in S1601 (S1603).

The MPPK 101 writes the value calculated in S1603 or S1604 into the DSC field 10222 of the record of the DCT 1022 of both controllers (S1605).

Last, the lock status field 10223 is changed to unlock, and the processing ends.

As described above, in Embodiment 1, regardless of the storage system 10 in which the owner MPPK is allocated to each LU, when it is decided that dirty data is not present in the target region of the read command, either MPPK 101 of not only the MPPK 101 of the owner of the LU including the target region but also the MPPK 101 of the non-owner can process the read command. Therefore, when dirty data is not present, the MPPK 101 other than the MPPK 101 of the owner can also process the read command. Consequently, in the storage system 10 in which the MPPK 101 of the owner is allocated in each LU, the processing performance of the I/O command can be improved, by flexibly dispersing the load to the MPPK 101.

That is, in the storage system 10 in Embodiment 1, when the MPPK in charge of port decides whether dirty data is included in the page unit, by using the DCT 1022, the non-owner MPPK can also execute the read I/O processing. Accordingly, in the read I/O in which the MPPK in charge of port and the owner MPPK are different, which is called a cross I/O processing, the processing that the MPPK in charge of port allocates the command to the owner MPPK becomes unnecessary, and the cross I/O processing can be speeded up.

In Embodiment 1, when it is decided that there is a possibility of presence of dirty data in the target region of the read command, the MPPK 101 of the owner of the LU processes the read command. Consequently, a range of the MPPK 101 that processes the read command can be easily determined according to a result of the decision about the possibility of presence of dirty data.

In Embodiment 1, at the time of processing the read command, the flexible load dispersion of the MPPK 101 as described above is applied to a configuration in which the read data can be also stored into the DXBF 1026 instead of storing the read data into the CM 1024. By employing the method of enabling the MPPK 101 other than the MPPK 101 of the owner to process the read command when dirty data is not present in the operation state in which there is a relatively high possibility of dirty data being not present, like in the CB mode, the effect of the processing performance of the I/O command in the storage 10 becomes higher.

Further, in Embodiment 1, the flexible load dispersion of the read command of the MPPK 101 as described above is applied to a configuration in which when the MPPK 101 receives a write command to the LU of which the owner is not the self, the MPPK 101 transfers the write command to the MPPK 101 which is the owner of the LU. In the storage system 10 in which dirty data is stored in the CM 1024 corresponding to the MPPK 101 of the owner, the read command can be efficiently processed according to presence or absence of dirty data.

Further, in Embodiment 1, the MPPK 101 manages a count value of write data which is counted up when the write data has been stored in the CM 1024 and which is counted down when the write data has been destaged from the CM 1024, in each disk region of a predetermined unit (a plurality of pages into which the LU is divided, as an example). When the count value is zero, the MPPK 101 decides that dirty data is not present in the disk region. According to this method, presence or absence of dirty data in the disk region of a predetermined unit can be managed by a counter, and it is possible to easily decide that dirty data is not present. The disk region of a predetermined unit is a page as an example. The count value of dirty data is obtained by counting a plurality of slots into which a page is divided.

In Embodiment 1, in processing the read command, there are a CB mode (CB mode ON) in which the read data is not stored in the CM 1024 but is stored in the DXBF 1026, and a cache storing mode (CB mode OFF, normal mode) in which the read data is stored in the CM 1024. When the cache hit rate becomes low to a predetermined value, the mode becomes the CB mode. According to this, when the cache hit rate becomes low, the mode becomes the CB mode. As a result, a possibility that dirty data is not present increases, and a processing effect of efficiently executing the read access to the LU in which dirty data is not present by using the non-owner MPPK becomes high.

### Embodiment 2

According to a storage system in Embodiment 2, an MPPK in charge of port refers to the operating rate of an owner MPPK, and when the operating rate of the owner MPPK is equal to or higher than a threshold value, the MPPK in charge of port transfers a read command to an MPPK of which the operating rate is the lowest. By this arrangement, even when read I/Os are concentrated in one LU, throughput performance of the storage system can be improved by dispersing the processings to whole MPPKs in the storage system.

The I/O processing flow of the storage system according to Embodiment 2 is different, in the read processing flow, from the I/O processing flow of the storage system according to Embodiment 1. The write processing flow in Embodiment 2 is the same as that in Embodiment 1, except that the CB mode ON/OFF changeover processing (S150 in S130) is not executed in Embodiment 2.

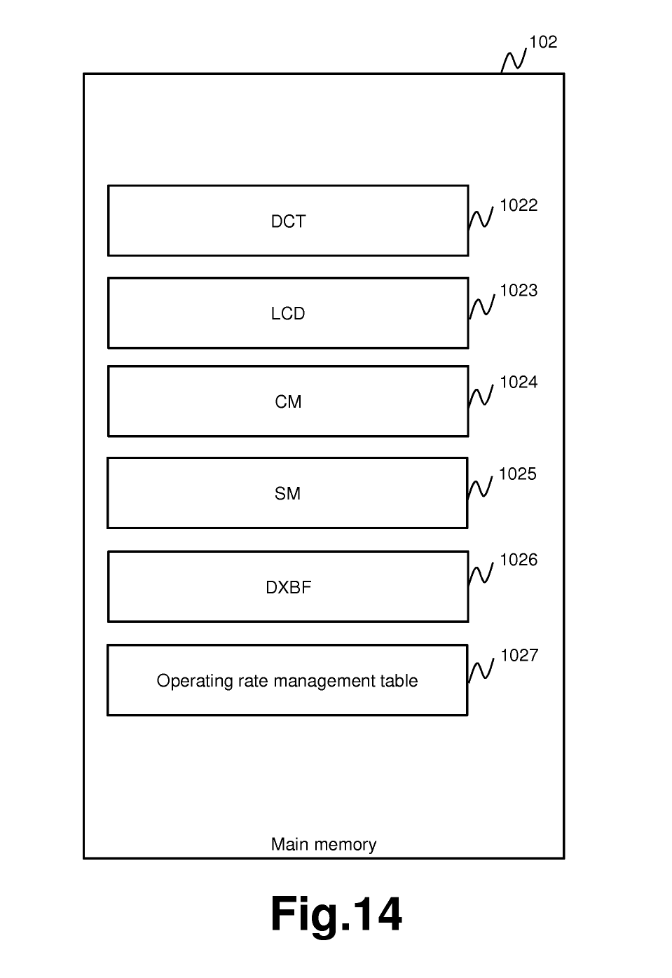

FIG. 14 is a block diagram showing information which is stored in the main memory 102 in Embodiment 2. The main memory 102 includes the DCT 1022, the LCD 1023, the CM 1024, the SM 1025, and a DXBF 1026, and further includes an operating rate management table 1027. The operating rate management table 1027 will be described later.

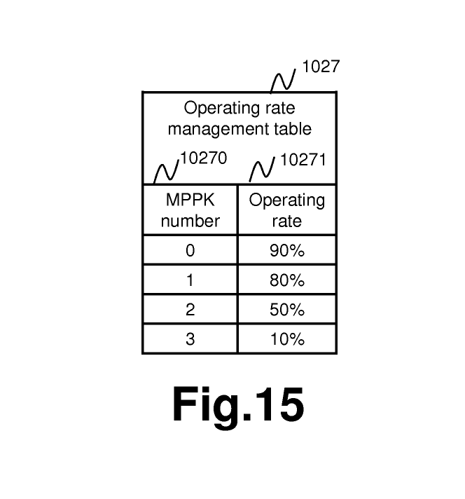

FIG. 15 is a diagram showing an example of the operating rate management table 1027. The operating rate management table 1027 is configured by an MPPK number field 10270 and an operating rate field 10271, and provides information of an operating rate in each MPPK.

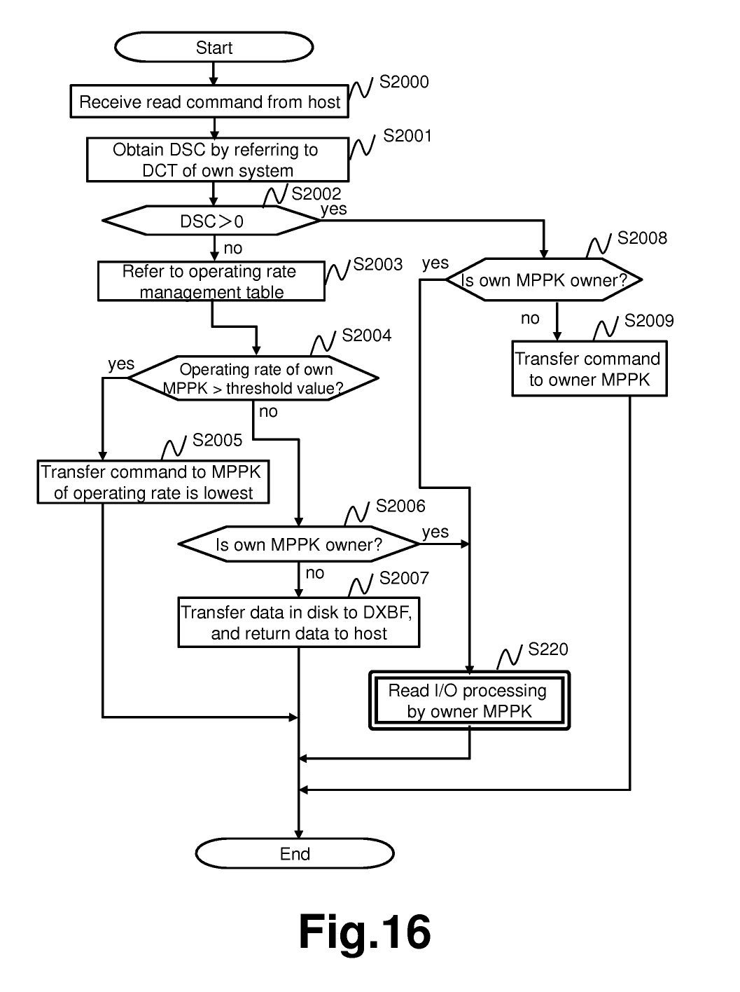

The I/O processing flow in Embodiment 2 will be described with reference to FIGS. 16 to 18.

FIG. 16 is a flowchart of a read I/O processing by the MPPK in charge of port.

After the storage system 10 receives the read command from the host computer 20, the MPPK in charge of port processes (S2000).

At first, in order to decide whether the non-owner MPPK can process the read I/O, the MPPK in charge of port obtains the DSC by referring to the DCT 1022 of the own system (S2001). The DCT 1022 of the own system refers to the DCT 1022 in the same controller 100 as that of the non-owner MPPK.

When the DSC has a value larger than 0 (S2002: yes), the corresponding page includes a dirty slot, and therefore, the MPPK in charge of port needs to process the read I/O processing by the owner MPPK.

When the own MPPK is the owner (S2008: yes), the MPPK in charge of port continues the read I/O processing by itself (S220). When the own MPPK is not the owner (S2008: no), the MPPK in charge of port transfers the command to the owner MPPK. A detailed flow of the read I/O processing (S220) by the owner MPPK will be described later.

When the DSC has a value 0 (S2002: no), the corresponding page does not include a dirty slot, and therefore, the non-owner MPPK can execute the read I/O processing. The MPPK in charge of port refers to the operating rate management table, to decide which MPPK to execute the read I/O processing (S2003).

When the operating rate of the own MPPK exceeds the threshold value (S2004: yes), the MPPK in charge of port transfers the command of the read I/O processing to the MPPK 101 of which operating rate is lowest (S2005).

When the operating rate of the own MPPK is equal to or lower than the threshold value (S2004: no), the MPPK in charge of port does not transfer the command to other MPPK, continues the read I/O processing by the own MPPK, and decides whether the own MPPK is the owner (S2006).

When the own MPPK is the owner (S2006: yes), the MPPK in charge of port executes the read I/O processing by the owner MPPK (S220). When the own MPPK is not the owner (S2006: no), the MPPK in charge of port transfers the data in the disk device 200 to the DXBF 1026, and returns the data to the host computer 20 (S2007).

However, as other example, by omitting S2006, the MPPK in charge of port may consistently execute S2007 when a decision in S2004 is yes.

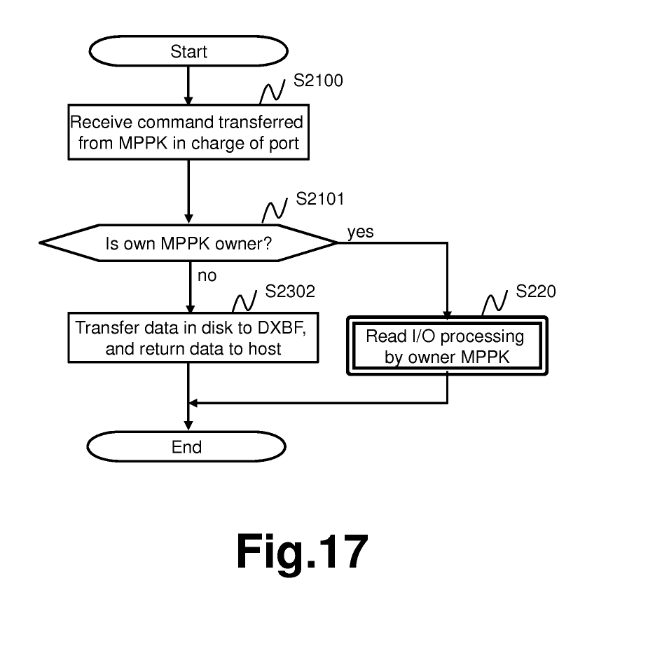

FIG. 17 is a flowchart of the read I/O processing by the MPPK not in charge of port.

When the command has been transferred from the MPPK in charge of port, the MPPK not in charge of port starts the processing (S2100).

The processing to be executed is different depending on whether the own MPPK is the owner or the non-owner of the LU which is the target of the command, the MPPK not in charge of port first decides whether the own MPPK is the owner (S2101). When the own MPPK is the owner (S2101: yes), the MPPK not in charge of port executes the read I/O processing by the owner MPPK (S220). When the own MPPK is not the owner (S2101: no), the MPPK not in charge of port transfers the data read from the disk device 200 to the DXBF 1026, and returns the data to the host computer 20 (S2302).

A detailed flow of the read I/O processing (S220) by the owner MPPK will be described later.

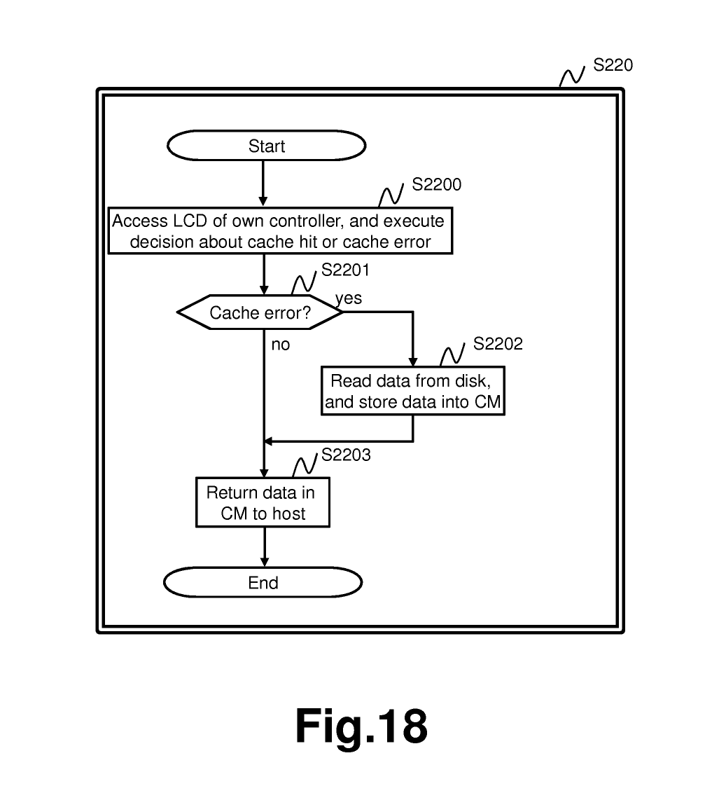

FIG. 18 is a flowchart of the read I/O processing (S220) by the owner MPPK.

This processing is executed only when the MPPK in charge of port has been decided as the owner MPPK, and the processing includes accessing the LCD 1023.

First, the owner MPPK accesses the LCD 1023 of the own controller, and executes the decision about whether cache hit or cache error occurred (S2200).

In the case of cache error (S2201: yes), because the target data is not present in the CM 1024, the owner MPPK reads data from the disk device 200, stores the data into the CM 1024 (S2202), and returns the data to the host computer 20 (S2203).

In the case of cache hit (S2202: no), the owner MPPK returns the data present in the CM 1024 to the host computer 20 (S2203).

As described above, in the storage system 10 according to Embodiment 2, the MPPK in charge of host decides presence or absence of dirty data by referring to the DCT 1022, and determines the MPPK 101 that becomes a command allocation destination by referring to the operating rate management table 1027. Therefore, it becomes possible to offload the read I/O processing to the MPPK 101 of a low operating rate other than the owner MPPK. When the read I/O processings are concentrated in one LU, the processing performance can be improved.

### REFERENCE SIGNS LIST

10 Storage system
100 Controller
101 MPPK
102 Main memory
1021 Hit rate management table
10210 LU number field
10211 Pattern field
10212 Hit rate field
10213 Staging execution number-of-times counter field
1022 DCT
10220 LU number field
10221 Page number field
10222 DSC field

1. A storage system comprising:
a disk device having storage regions that are managed as a plurality of logical units;
a plurality of processors that process read commands to the disk device; and
a cache that the processors can use to process the read commands, wherein
an owner processor that is in charge of processing to each of the logical units is allocated to each of the logical units, and
when decision is made that dirty data is not present in the cache in a target region of the read command, a non-owner processor, as the processor other than the owner processor of a logical unit that includes the target region, processes the read command.

2. The storage system according to claim 1, wherein
when decision is made that there is a possibility of presence of dirty data in the cache in a target region of the read command, the owner processor of the logical unit processes the read command.

3. The storage system according to claim 1, further comprising
a buffer that temporarily stores data, wherein
when processing the read command, the storage system does not store read data of the read command into the cache, but stores the read data into the buffer.

4. The storage system according to claim 1, wherein
when the processor receives a write command to the logical unit, which is not owned by the processor as the owner processor, the processor transfers the write command to the owner processor of the logical unit.

5. The storage system according to claim 1, wherein
the processor manages, in each of the storage regions of a predetermined unit which configure the logical units, a dirty check count value, which is counted up when write data is stored in a cache region in the cache corresponding to the storage region, and which is counted down when destaging is performed from a cache memory corresponding to the storage region, and
when the dirty check count value is zero, the processor decides that dirty data is not present in the disk region.

6. The storage system according to claim 5, wherein
the dirty check count value is counted in a plurality of slot units into which the storage regions of the predetermined unit are divided.

7. The storage system according to claim 3, wherein
in processing the read command, there are a cache bypass mode in which read data is not stored in the cache but is stored in the buffer, and a cache storing mode in which read data is stored in the cache, and
when a hit rate of the cache becomes low to reach a predetermined value, a mode enters the cache bypass mode.

8. The storage system according to claim 1, wherein
when decision is made that dirty data is not present in a target region of the read command, the processor, the operating rate of which is lowest, processes the read command.

9. A processing method by a controller having a plurality of processors that process read commands to a disk device and a cache that the processors can use to process the read commands, in a storage system having a disk device having storage regions that are managed as a plurality of logical units,
the method comprising: allocating to each of the logical units an owner processor that is in charge of processing to each of the logical units,
when decision is made that dirty data is not present in the cache in a target region of the read command, a non-owner processor, as the processor other than the owner processor of a logical unit that includes the target region, processes the read command.

10. The processing method according to claim 9, wherein
when decision is made that there is a possibility of presence of dirty data in the cache in a target region of the read command, the owner processor of the logical unit processes the read command.

11. The processing method according to claim 9, wherein
the storage system further comprises a buffer that temporarily stores data, and
when processing the read command, the storage system does not store read data of the read command into the cache, but stores the read data into the buffer.

12. The processing method according to claim 9, wherein
when the processor receives a write command to the logical unit which is not owned by the processor as the owner processor, the processor transfers the write command to the owner processor of the logical unit.

13. The processing method according to claim 9, wherein
the processor manages, in each of the storage regions of a predetermined unit which configure the logical units, a dirty check count value, which is counted up when write data is stored in a cache region in the cache corresponding to the storage region, and which is counted down when destaging is performed from a cache memory corresponding to the storage region, and
when the dirty check count value is zero, the processor decides that dirty data is not present in the disk region.

14. The processing method according to claim 11, wherein
in processing the read command, there are a cache bypass mode in which read data is not stored in the cache but is stored in the buffer, and a cache storing mode in which read data is stored in the cache, and
when a hit rate of the cache becomes low to reach a predetermined value, a mode enters the cache bypass mode.

15. The processing method according to claim 9, wherein
when decision is made that dirty data is not present in a target region of the read command, the processor, the operating rate of which is lowest, processes the read command.
